(19) United States
(12) Patent Application Publication
(10) Pub. No.: US 2010/0073248 A1
(43) Pub. Date: Mar. 25, 2010

(54) FLAT ANTENNA GROUND PLANE SUPPORTING BODY INCLUDING QUARTER-WAVE TRAPS

(76) Inventors: Eduardo Motta Cruz, Saint Herblain (FR); John Bartholomew, Strasbourg (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/447,654

(22) PCT Filed: Nov. 7, 2007
(86) PCT No.: PCT/EP07/61980

§ 371 Date: Apr. 28, 2009

(30) Foreign Application Priority Data
Nov. 8, 2006 (FR) 06/09744

(51) Int. Cl. H01Q 1/12; H01Q 13/00

(52) U.S. Cl. 343/772; 343/878

(57) ABSTRACT

An flat antenna ground plane supporting body including a longitudinal channel defining a waveguide for the antenna and two rectangular grooves which extend along the length of the channel and which are arranged on either side of the channel so as to define a double quarter-wave trap. The part of the body between the channel and each groove is machined such that when the ground plane is mounted on the body, the part of the body is separated from the ground plane by an air cushion of a controlled dimension (b). The invention also relates to a flat antenna including a substrate, a substrate-supporting ground plane and a body as described above, to which the ground plane is applied or secured.

The field of the invention is that of telecommunication antennae, and more particularly that of flat antennae for radio-relay systems, fed via a waveguide.

More particularly, the invention concerns a flat antenna fed directly by a waveguide by the use of electromagnetic slot coupling between the waveguide and each of the feeder lines of the radiating elements of the flat antenna.

As described in the French patent application of the Applicant, submitted on 14 Nov. 2005 with the number 0511527, for example, such coupling can be achieved by arranging for slots in the ground plane of the antenna opposite to each radiating element feeder line, and a waveguide arranged in relation to the ground plane so as to effect electromagnetic slot coupling between the waveguide and each of the feeder lines.

According to one possible embodiment, the waveguide is U-shaped in section, and is arranged so that the ground plane closes the opening in the waveguide (the ground plane is then used as one wall of the waveguide).

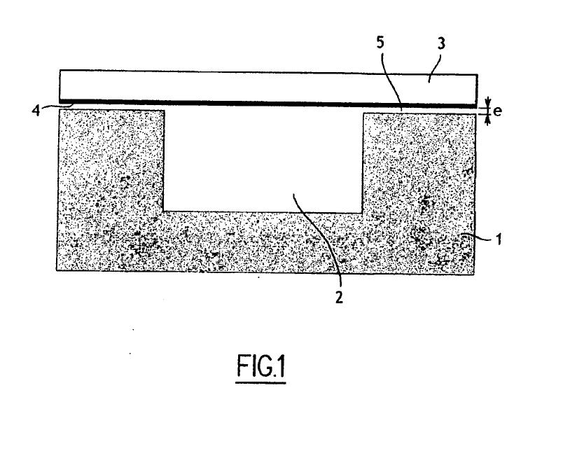

FIG. 1 presents a schematic view in section of this embodiment. A canal, created by milling for example, in a metal body 1 forms a waveguide 2 that is U-shaped in section.

The substrate 3 of the antenna rests on a ground plane 4, this ground plane 4 then being used as one wall of the waveguide 2 so as to close the opening in the waveguide.

Because of manufacturing imperfections and the small thickness of the substrate 3, the surface of the ground plane 4 used as a wall of the waveguide 2 is liable to exhibit a “gondola effect”.

An irregular electrical contact can then be established between the ground plane and the waveguide. And as shown in FIG. 1, an air layer 5 is then able to exist, at least locally, between the waveguide 2 and the ground plane 4.

The electromagnetic field then tends to propagate between the waveguide and the ground plane, which can result in significant losses.

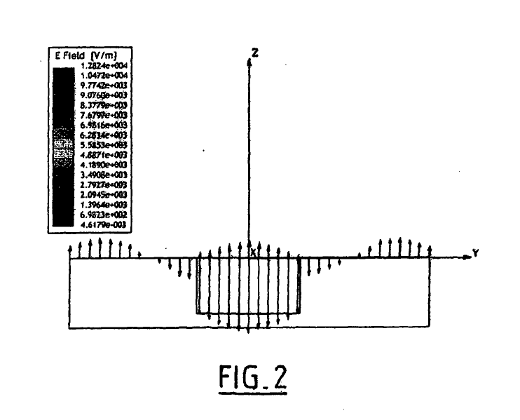

FIG. 2 represents a map of the field E of the embodiment of FIG. 1 according to one view in cross section. This figure illustrates the behaviour of an electromagnetic wave passing through a section of waveguide closed by a ground plane, with an air layer with a thickness e of about 0.05 mm (see FIG. 1), which is a thickness of the same order of magnitude as the manufacturing and assembly imperfections of the mechanical parts.

It is possible to observe the presence of a progressive sideband that gives rise to significant transmission losses, of the order of 15 dB over a guide section of 16 cm.

It will be noted that the use of a double quarter-wave trap has been proposed in order to achieve the attachment of the substrate of the antenna to the top of the waveguide with no welding, so as to avoid any unforeseen electrical behaviour.

The article of Van Per Wilt and Strijbos, entitled “A 40 GHz planar array antenna using hybrid coupling” (in “Perspectives on Radio Astronomy—Technologies for Large Antenna Arrays, Proceedings of the Conference held at the ASTRON Institute in Dwingeloo on 12-14 Apr. 1999”. ISBN: 90805434-2-X, 354 pages, 2000, p. 129) thus proposes (see FIG. 6 and corresponding discussion) to associate a double quarter-wave trap (of “double quarter-wave choke construction” according to the terminology used in this article) with the waveguide. The substrate can then be attached to the waveguide by simple gluing.

A metal body to support the ground plane of a flat antenna according to the preamble of claim 1 is known from the article of Kimura et al. entitled “Alternating-phase fed single-layer slotted waveguide arrays with choke, dispensing with narrow wall contacts”, IEE Proceedings H. Microwaves, Antennas & Propagation, Institution of electrical engineers; Stevenage, G B, vol. 148, No. 5.

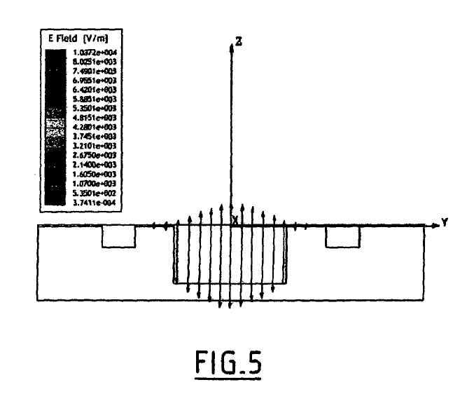

This article proposes to examine the respective influence of the depth c and the position w of the trap according to one analysis model (see 1st paragraph, right column on page 297, and corresponding FIG. 5), according to which, when the ground plane is attached to the body, one is considering a space (a “gap”) with a height of 0.1 mm over all the length of the body junction—the ground plane. In addition, this article states (see last paragraph, right column on page 297, with reference to FIG. 6) that the gap of constant height considered in the analysis model is artificial (“artificial, small gap of constant height”). It can be seen that this separation of 0.1 mm corresponds to a simulation of leakage currents over all the length of the body/ground-plane junction.

Now as mentioned previously, in reality, because of manufacturing imperfections, the ground plane presents a gondola effect. An irregular electrical contact is then liable to be established between the ground plane and the body, leading to transmission losses. The aforementioned article also recognises this problem of irregular electrical contact (see left column on page 296, paragraph beginning with “Secondly, . . . ”, in which it is stated that the losses (“leakage”) can be eliminated if one could provide a regular electrical contact, and again on page 297, left column, 1st paragraph of section 3, “Loss from waveguide with choke”.

It will thus be seen that in reality, the “gap” of this article is not of uniform thickness but, on the contrary, is subject to the imperfections of the ground plane and its gondola effect. In other words, in reality, this gap is not of constant height. It is therefore only in an analysis model that this article artificially considers a gap of constant height.

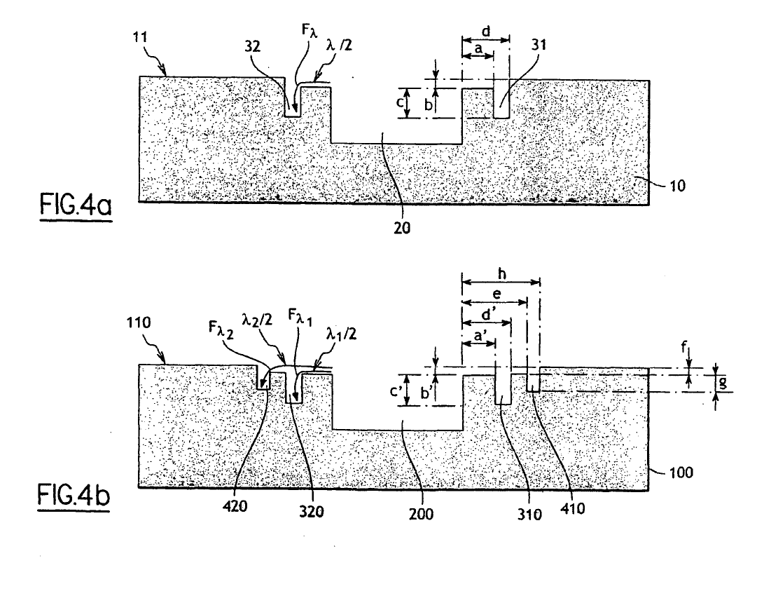

It will also be recognised that this gap extends for the full length of the body/ground-plane junction, and is not merely the machining of one portion only of this junction. In particular, this article shows no machining of the part of the body located between the waveguide and each of the slots of the double trap (see FIGS. 4 and 5a), and no means of controlling, in a practical manner, the thickness of the air layer separating this part of the body from the ground plane.

The purpose of the invention is to reduce the transmission losses in order to increase the efficiency of the antenna. It aims more particularly to minimise the losses in the waveguide and in the working frequency range of the flat antenna.

To this end, and according to a first aspect, the invention proposes a metal body to support the ground plane of a flat antenna that includes:
a longitudinal channel forming a waveguide for the antenna;
two rectangular slots extending along the length of the channel, and arranged on either side of the channel in order to form a double quarter-wave trap;

characterised in that the part of the body located between the channel and each slot is machined so that when the ground plane is attached to the body, the said part of the body is separated from the ground plane by an air layer of controlled dimensions.

Certain preferred but not limiting aspects of this metal body are as follows:
the air layer has a thickness that is greater than the manufacturing precision of the ground plane;
the air layer has a thickness that is less than the wavelength λ associated with the frequency f to which the double trap is tuned;
the air layer has a thickness of between 0.05 mm and 1 mm;
the air layer has a thickness of about λ/10, where λ represents the wavelength associated with the frequency f to which the double trap is tuned;
the part of the body located between the channel and each slot extends over a distance (a) equal to λ/4, and each slot has a depth (c) equal to λ/4, where λ represents the wavelength associated with the frequency f to which the double trap is tuned;
the double trap is tuned to the centre frequency f of the working frequency band of the antenna;
the body includes a multiplicity of pairs of rectangular slots extending along the length of the channel, with the slots of each pair being arranged on either side of the channel in order to form a corresponding multiplicity of double quarter-wave traps, each double trap being tuned to a different frequency;
the body includes two pairs of slots forming two double quarter-wave traps, with the dimensions of the first trap tuned to a first frequency f1 (wavelength λ₁) are as follows: guide-trap distance: a′=λ₁/8, depth of the trap c′=3λ₁/8, thickness of the air layer b′=λ₁/10, sum d′ of guide-trap distance and width of the trap d′=λ₂/4; and the dimensions of the second trap tuned to a second frequency f₂ (wavelength λ₂) are as follows: guide-trap distance e=3*λ₂/8, depth of the trap g=λ₂/8, thickness of the air layer f=λ₂/10, sum h of guide-trap distance and width of trap h=λ₂/2; and

the doubles traps are tuned to the duplex frequencies of the top and bottom channels of a working frequency band of the antenna.

According to a second aspect, the invention concerns an antenna with a substrate, a ground plane supporting the substrate and a body according to the first aspect of the invention against which the ground plane is clamped or fixed.

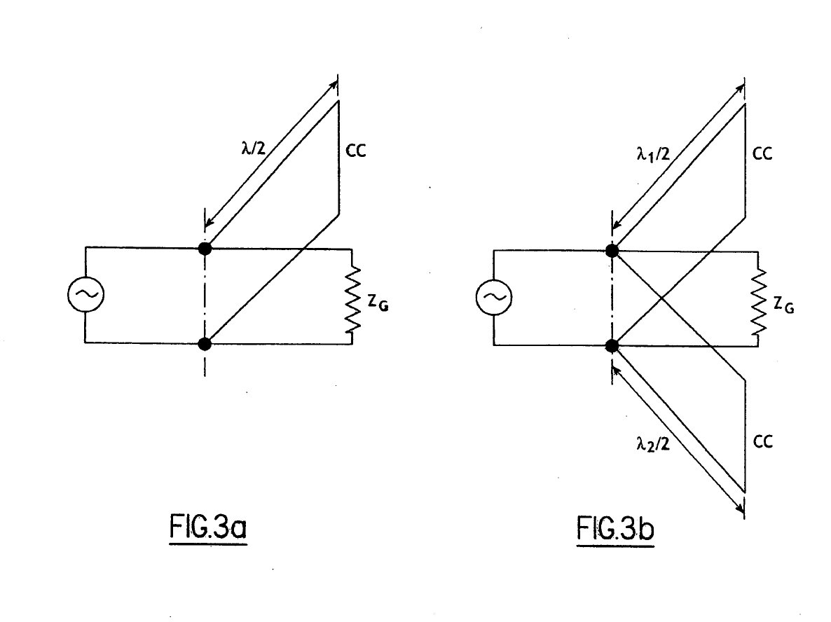

Other aspects, objectives and advantages of the present invention will appear more clearly on reading the detailed description that follows of preferred embodiments of the latter, which are given by way of non-limiting examples only, and with reference to the appended drawings in which, in addition to FIGS. 1 and 2 already described:
FIGS. 3a and 3b represent the introduction, on the equivalent circuit of a guide represented by its characteristic impedance Z_{G}, and with one double quarter-wave trap and two double quarter-wave traps respectively;
FIG. 4a represents one possible embodiment of a metal body according to the invention with a double quarter-wave trap;
FIG. 4b represents one possible embodiment of a metal body according to the invention with two double quarter-wave traps;
FIG. 5 represents a map of the electric field according to one view in cross section of the coupling effected by one embodiment of the invention.

According to a first aspect, the invention concerns a body, typically a metal body, made of aluminium for example, intended to act as the ground-plane support for a flat antenna. For its part, the ground plane supports the dielectric substrate of the antenna, on which are placed the radiating elements of the antenna.

As represented in the views in section of FIGS. 4a and 4b, a longitudinal channel 20, 200 forming a waveguide for the antenna is created, by milling for example, in a metal body 10, 100.

The cross-section of the channel is typically rectangular and U-shaped in section, with the ground plane of the antenna being intended to act as a wall to close the opening in the waveguide.

The dimensions of the channel are a height (lateral branches of the U) of λc/4 and a width (base of the U) of λc/2, where λc represents the wavelength corresponding to the cut-off frequency of the guide (with the guide acting as a high-pass filter, for the frequencies above the cut-off frequency).

Pairs of rectangular slots 31, 32; 310, 320; 410, 420 extending along the length of the channel are also arranged in the body 10 on either side of the channel 20, 200 so that each forms a double quarter-wave trap.

These slots are created by milling of the metal body for example.

In the context of the invention, the term “double quarter-wave trap” should be understood as meaning two quarter-wave traps arranged symmetrically on either side of the waveguide.

For its part, the term “quarter-wave trap” refers to a slot arranged in the body so as to form an electrical section, of a length equal to λ/2, from the wall of the channel (where λ represents the wavelength in the guide of the signal propagated by the antenna, remembering that λ=c/f, where c is the velocity and f the frequency. This section, of length λ/2, effectively allows a short-circuit (shown by the reference CC in FIGS. 3a and 3b) to be created at the wall of the channel forming the waveguide (zero limiting condition of the field tangential to the wall at this location).

FIG. 3a shows the introduction of a double quarter-wave trap on the equivalent circuit of a guide represented by its characteristic impedance Z_{G}. Here one is seeking to create a trap tuned to the centre frequency f (where λ=c/f) of the working frequency band of the antenna.

As an example, for an antenna operating in the band from 37.21 to 38.64 GHz, the centre frequency f is 37.92 Hz.

In order to obtain a wider frequency range, it is possible to design additional traps, by creating other short-circuits in addition to the first.

In this regard, FIG. 3b represents the introduction of two double quarter-wave traps in order to obtain a wider frequency range, by using two close frequencies f₁ and f₂ (where λ₁=c/f₁ and λ₂=c/f₂). The traps are then tuned to the frequencies fᵢ and f₂ respectively.

In the embodiment of FIG. 3b, we thus create a second short-circuit CC in addition to the first. This then provides two electrical paths in parallel for the two operating frequencies f₁ and f₂.

As an example, for an antenna operating in the band from 37.21 to 38.64 GHz, we choose the two duplex frequencies corresponding to the central frequencies f₁, f₂ of the top and bottom channels, or 38.64 GHz and 37.21 GHz respectively.

In the context of the invention, the section of length λ/2 used to create a short-circuit CC at the lateral wall of the guide includes two portions that, placed end-to-end, represent λ/2.

As indicated in FIGS. 4a and 4b, these portions are respectively:
the distance (a); (a′); (e) separating the channel 20, 200 (lateral wall of the channel with zero limiting condition of the electric field) and a slot 31, 32; 310, 320; 410, 420 (this distance thus representing the width of the “plateau”, meaning the width of the part of the body located between the waveguide and the trap); and
the depth (c); (c′); (g) of the slot 31, 32; 310, 320; 410, 420 (the “pit” of the trap).

In other words, we observe the following relations in order to form the quarter-wave traps:
in FIG. 4a representing the implementation of a single double-trap tuned to frequency f (where λ=c/f): λ/2=a+c;
in FIG. 4b representing the implementation of two double-traps tuned respectively to frequencies f₁ and f₂ (where ═ᵢ=c/f₁ and λ₂=c/f₂): λ₁/2=a′+c′ and λ₂/2=e+g.

In FIGS. 4a and 4b, we have shown in the form of arrows Fλ, Fλ₁, and Fλ₂ those sections of length λ/2 that form the quarter-wave traps, so reducing the in-line losses in the guide.

Effectively, by means of these traps, the progressive side band is eliminated by creating a short-circuit on the lateral wall of the guide using a stationary wave.

In addition, the invention arranges that the part of the body located between the channel and each slot (the “plateau”) should be machined so that when the ground plane is attached to the surface 11, 110 of the body 10, 100, the said part of the body is separated from the ground plane by an air layer of controlled dimensions.

The thickness of this air layer bears the reference b in FIG. 4a, and the references b′ and f in FIG. 4b.

The ability to control the thickness of the air layer is used to prevent the ground plane from establishing an electrical contact with the body of the waveguide. We thus overcome some of the drawbacks associated with the manufacturing imperfections of the parts, by ensuring over all the length of the waveguide the presence of a quarter-wave trap at a given operating frequency.

Considering a manufacturing precision of the mechanical parts of the order of 0.01 mm, the part of the body between the channel and the slot is then machined so that the thickness b, b′, f of the air layer is greater than this inaccuracy, and greater than 0.05 mm, for example.

In addition, the thickness of the air layer is also controlled by machining the part of the body between the channel and the slot in order that this thickness remains sufficiently small in relation to the wavelength of the operating frequency, as well as in relation to the small side of the guide (lateral wall of the U). Here it means privileging the propagation of the main TE10 mode, and avoiding the creation of other undesirable modes by excessive deformation of the cross section of the waveguide.

In the case of an operating frequency of 38 GHz, the machining is then effected, for example, so that the thickness of the air layer is less than 1 mm.

According to one preferred embodiment, this thickness is set to λ/10 (which is 0.78 mm for an operating frequency of 38 GHz).

Returning to the description of the implementation of the body represented in FIG. 4a with a double trap, the following is a list of the preferred dimensioning rules:
the distance (a) between the guide and the trap is λ/4;
the depth (c) of the trap is λ/4 (verifying that a+c′=λ/2);
the thickness of the air layer (b) is λ/10;
the width (d) of the trap is λ/8.

FIG. 5 shows a map of the field E according to one view in cross section, for the embodiment of FIG. 4a, in which we considered an air layer (not shown in this figure) such that b′=0.05 mm (minimum value of the range 0.05-1 mm presented above).

By comparing FIG. 5 with FIG. 2, we observe the elimination of the progressive side band. The transmission losses quantified for a section of 16 cm are less than 1 dB (compared to the 15 dB of losses on a device with no trap).

And for the embodiment, represented in FIG. 4b, of the body with two double-traps, the preferred dimensioning rules are as follows (considering frequencies f₁ and f₂ as relatively close, as in the example selected here of the duplex frequencies of a 38 GHz antenna):
for the first double trap tuned to λ₁ (slots 310 and 320):
guide-trap distance a′=λ₁/8;
depth of the trap c′=3λ₁/8 (verifying that a′+c′λ₁/2);
thickness of the air layer b′ λ₁/10;
sum d′ of the guide-trap distance a′ and the width of the trap d′λ₂/4.
for the second trap tuned to λ₂ (slots 410 and 420):
guide-trap distance e=3*λ₂/8;
depth of the trap g=λ₂/8 (verifying that e+g=λ₂/2)
thickness of the air layer f=λ₂/10;
sum h of the guide-trap distance e and width of the trap h=λ₂/2.

Naturally, it will have been understood that the invention is not limited by the number of double traps. In particular, in order to obtain a still wider frequency range, it is possible to design additional traps, by creating other short-circuits in addition to those already in existence. As an example, it is thus possible to create a metal body fitted with a multiplicity of double traps by arranging for a corresponding multiplicity of pairs of slots, with these slots respecting the dimensioning rules presented above.

In addition, the invention is not limited to a metal body, but extends also to include any flat antenna that has such a metal body.

In particular, the invention extends to a flat antenna with a substrate, a ground plane supporting the substrate and a body according to the first aspect of the invention, against which the ground plane is clamped or fixed, by gluing for example.

The antenna includes radiating elements placed on the substrate with one or more feeder lines to the said radiating elements, and the ground plane can have one or more slots opposite to each feeder line so as to effect electromagnetic slot coupling by between the waveguide and each feeder line.

1. A body (10, 100) to support the ground plane of a flat antenna that includes:
a longitudinal channel (20, 200) forming a waveguide for the antenna;
two rectangular slots (31, 32; 310, 320; 410, 420) extending along the length of the channel (20, 200), and arranged on either side of the channel in order to form a double quarter-wave trap;
characterised in that the part of the body located between the channel and each slot is machined so that when the ground plane is attached to the body, the said part of the body is separated from the ground plane by an air layer of controlled dimension (b; b′; f).

2. A body according to claim 1, characterised in that the air layer has a thickness greater than the manufacturing precision of the ground plane.

3. A body according to one of the preceding claims, characterised in that the air layer has a thickness that is less than the wavelength λ associated with the frequency f to which the double trap is tuned.

4. A body according to one of the preceding claims, characterised in that the air layer has a thickness of between 0.05 mm and 1 mm.

5. A body according to one of the preceding claims, characterised in that the air layer has a thickness of about λ/10, where λ represents the wavelength associated with the frequency f to which the double trap is tuned.

6. A body according to one of claims 1 to 5, characterised in that the part of the body located between the channel and each slot extends over a distance (a) equal to λ/4, and each slot has a depth (c) equal to λ/4, where λ represents the wavelength associated with the frequency f to which the double trap is tuned.

7. A body according to the preceding claim, characterised in that the double trap is tuned to the centre frequency f of the working frequency band of the antenna.

8. A body according to one of claims 1 to 5, characterised in that it includes a multiplicity of pairs of rectangular slots extending along the length of the channel, with the slots of each pair being arranged on either side of the channel in order to form a corresponding multiplicity of double quarter-wave traps, with each double trap being tuned to a different frequency (f₁, f₂).

9. A body according to the preceding claim, characterised in that it includes two pairs of slots forming two double quarter-wave traps, in that the dimensions of the first trap tuned to a first frequency f₁ (wavelength λᵢ) are as follows: guide-trap distance a′=λ₁/8, depth of the trap c′=3λ₁/8, thickness of the air layer b′=λ₁/10, sum d′ of guide-trap distance and width of trap: d′=λ₂/4; and in that the dimensions of the second trap, tuned to a second frequency f₂ (wavelength λ₂) are as follows: guide-trap distance e=3*λ₂/8, depth of the trap g=λ₂/8, thickness of the air layer f=λ₂/10, sum h of the guide-trap distance and width of the trap h=λ₂/2.

10. A body according to one of the two the preceding claims, characterised in that the double traps are tuned to the duplex frequencies of the top and bottom channels of a working frequency band of the antenna.

11. A flat antenna with a substrate, a ground plane supporting the substrate and a body (10, 100) according to one of the preceding claims, against which the ground plane is clamped or fixed.

12. An antenna according to the preceding claim, characterised in that it includes radiating elements placed on the substrate, and one or more feeder lines to the said radiating elements, and in that the ground plane presents one or more slots opposite to each feeder line, so as to effect electromagnetic slot coupling between the waveguide and each feeder line.
